(19) United States
(12) Patent Application Publication
(10) Pub. No.: US 2010/0294974 A1
(43) Pub. Date: Nov. 25, 2010

(54) VALVE

(76) Inventor: Klaus Habr, Marktheidenfeld (DE)

Correspondence Address: MICHAEL J. STRIKER, 103 EAST NECK ROAD, HUNTINGTON, NY, 11743, US

(21) Appl. No.: 12/863,802

(22) PCT Filed: Feb. 12, 2009
(86) PCT No.: PCT/EP09/00969

§ 371 Date: Jul. 21, 2010

(30) Foreign Application Priority Data
Mar. 25, 2008 (DE) 10 2008 015 506.3

(51) Int. Cl. F16K 27/00

(52) U.S. Cl. 251/366

(57) ABSTRACT

The invention relates to a valve of an arbitrary type, comprising a valve body (4) for setting an opening cross-section through which pressure medium flows and a barrier body (22) against or around which pressure medium flows, characterized in that the barrier body (22) is attached to the valve body (4). Due to the flow against or around the barrier body (22), a force is generated, particularly in the opening direction of the valve body (4).

The invention relates to a valve according to the preamble of claim 1.

In valves of that type, an opening cross-section is controlled open using a valve body, e.g. a valve spool or a seat body, thereby enabling pressure medium to flow through the valve body depending on the pressure differential across the opening cross-section. In the presence of high volumetric flow rates and in the high-pressure range in particular, considerable flow forces can act on the valve body in the closing direction, thereby resulting in a smaller opening cross-section than was originally provided e.g. by actuating the valve. To compensate for these flow forces that act in the closing direction, the control element used to adjust the valve body can be designed to have a correspondingly high actuating force, although a considerable amount of fabrication and control effort is required.

To avoid this disadvantage, solutions are provided in the related art in which flow forces that act in the closing direction are reduced using suitable flow guidance in the region of the opening cross-section. These solutions are based on changing the channel guidance between the valve housing and the valve body.

Publication U.S. Pat. No. 6,045,120 shows a poppet valve that includes a movable, specially shaped closing body and a counterpart that has a matching shape and is fixed to the housing, the two components jointly limiting a pressure-medium flow path that includes a plurality of redirections, and through which the pressure medium is guided and redirected when the valve is open such that the pressure medium exerts a force on the movable closing body that acts in the opening direction.

The disadvantage of this solution is the complex geometry, which is difficult to manufacture, and the considerable loss of pressure.

A method, which has a difficult design but which may be applied to regions having low pressure and low flow rates, for redirecting the flow force to a control edge is shown in the “Industrie-Anzeiger”, volume 83, no. 14, on page 21. In that case, the flow of pressure medium is redirected several times through a bushing fixed in a valve bore, thereby producing a force that acts in the opening direction.

Publications DE 1 952 811, DE 1 775 876 and U.S. Pat. No. 3,633,871 show a gate valve, in the case of which a barrier body in the form of a deflection plate that is situated perpendicularly to the flow direction is disposed in the flow channel of the control plunger. This deflector, which is fixed to the valve housing, and which can also be subdivided into four individual plates, is disposed in the vicinity of the outlet port and in the direction of flow, in front of an annular piston surface. When the valve is open, the plate holds the flow of pressure medium away from the piston surface to a large extent, thereby reducing the force that acts in the closing direction.

A similar design is presented in publications U.S. Pat. No. 3,543,648 and U.S. Pat. No. 3,630,230. To counteract closing forces that are present at the piston, the publications show a barrier body plate or guide plate that is fixed to the valve housing and is disposed in the outlet port, between two inlet ports. The plate largely prevents or interrupts the flow of pressure medium, which is initially directed past the outlet port, thereby reducing the resultant force that acts on the piston in the closing direction. The redirection that takes place on the plate also generates a flow of pressure medium in the direction toward the inlet port, which generates an additional force on the piston that acts in the opening direction.

The disadvantage of the known approaches to changing the force ratios on the valve piston is that changing the housing geometry results in the need to change the channel flow and, in the latter approach, the flow of pressure medium must be largely interrupted in order to change the flow ratios. As a result, a great deal of effort is required to implement housing changes.

In contrast, the problem addressed by the invention is to reduce the flow forces that act in the closing direction using a simple device.

This problem is solved by a valve according to claim 1.

The barrier body, against which or around which flow travels according to the present invention, is mounted on an adjustable valve body of the valve, thereby causing a force or force components that act in the opening direction of the valve body to be generated when the barrier body is acted upon by flowing pressure medium, in particular by an open jet that forms downstream of the cross-section through which flow travels. This takes place via the conversion of the kinetic energy of the open jet on the barrier body. In this manner, the opening force of the valve can be reduced by partially compensating for forces that act in the closing direction. As a result, control elements can be designed to be smaller and less complex, and energy consumption during operation of the valve according to the invention can be reduced. This advantage increases when the valve according to the invention is used in the high-pressure range since, in principle, higher adjustment forces are required there.

Preferably, the valve according to the invention or the barrier body according to the invention, and against which or around which flow travels, is designed such that an adjustment force or holding force that tends toward zero results on the valve body. Furthermore, if forces acting in the closing direction are over-compensated for, an overall force that acts in the opening direction can also result. A design of the barrier body of this type can be used to accelerate its opening action.

According to one embodiment, the valve body and the barrier body in combination form one part, thereby eliminating the need to attach the barrier body to the valve body.

As an alternative, the barrier body can also be attached to the valve body and include an annular base part, for example, which is inserted in an annular groove of the valve body, and the barrier body can include one or more flow bodies. One connection or, preferably, a plurality of connections (e.g. segments or radial segments) is used to connect the base part and the flow body or flow bodies. In this variant, valve bodies that are manufactured according to the related art can be easily retrofitted with the barrier body according to the invention. A barrier body composed of separate pieces as described above is easy to assemble.

In one embodiment according to the invention, the valve is a gate valve that includes a valve spool and a neck having a smaller diameter and being bounded laterally by two collars. The barrier body according to the invention is preferably fastened to the neck or the discharge chamber-side collar of the valve spool. In these two variants, the barrier body is disposed, according to the invention, behind the opening cross-section of the valve in the flow region of the pressure medium, wherein barrier bodies in the neck region have smaller diameters than barrier bodies in the collar region.

Depending on the design of the valve according to the invention, it can be advantageous to provide recesses between the radial segments or holes in the barrier body or in the flow body, the recesses being used as pressure-medium passages. The back pressure of the barrier body and, therefore, the force that is transferred to the valve body can be reduced or adjusted in this manner. If the barrier body according to the invention includes a plurality of flow bodies, recesses between the segments or the distances between the flow bodies cause flow to travel against or around the individual flow bodies, largely on all sides.

In an advantageous embodiment of the valve according to the invention, a flow body extends around the valve body in a circular or annular manner. In this case, a torus or an annular disc or a truncated cone are suitable in particular for use as flow bodies. The one-pieced flow body can also be composed of a part of a sphere or an ellipsoid. It is preferably composed of a cylindrical jacket or a cylindrical ring.

If the flow body is divided into a plurality of individual flow bodies or into a large number of individual flow bodies, each body is fastened to at least one radial segment or directly to the base part. Each individual flow body can be composed of a part of a torus, a part of an annular disc, a section of a sphere or a truncated cone, or of a section of a cylindrical jacket or cylindrical ring. Preferably, the one individual body can also be a sphere or an ellipsoid. The result is a large number of possible designs of the body according to the invention, which can be used to achieve the large number of possible valve types, valve variants, flow rates, pressure-medium viscosities, etc., or closing forces to be compensated for.

If the flow body is a cylindrical jacket or a cylindrical ring, for example, and includes an end face that opposes or is perpendicular to the direction of flow, then it is advantageously positioned obliquely. In this manner, the unwanted situation in which the pressure medium impacts the end face is prevented, and the bevel can act as a flow divider and a guide surface. The same applies when the flow body is subdivided into a plurality of planar formations having end faces.

In a preferred development, the flow body or flow bodies has/have a wing-type profile. In this manner, the known lifting forces on the flow body can be generated, and the force components that act in the adjustment direction of the valve body can be selected in an advantageous manner.

The various flow bodies mentioned above can also be combined in an arbitrary manner and distributed around the circumference evenly or unevenly. Furthermore, the radial distance of the various flow bodies can be varied. If e.g. two different distances and/or two body types are provided, a portion of the flow bodies can be optimally selected and adjusted for a first operating state which is used often, and another portion of the flow bodies can be optimally selected and adjusted for another often-used operating state of the valve according to the invention. This is advantageous, in particular, when the pressure medium or the open jet occurs in a spacially concentrated manner in the case of the valve type according to the invention. Moreover, a large number of various distances and/or body types is possible, thereby making it possible to apply force to the valve body over an adjustment range of the valve according to the invention.

In a particularly preferred embodiment of the valve according to the invention, a further, substantially annular flow guide body is fastened to the valve housing, or is inserted in an annular recess in the valve housing. This additional flow guide body, in conjunction with the barrier bodies or the flow bodies, limits a flow-through cross-section, wherein the two bodies are preferably installed in the discharge chamber.

Preferably, the additional flow guide body has a rounded guide surface that directs the pressure medium or the open jet in the direction of the barrier body or flow body in an optimal manner. It has proven advantageous to overlap the two bodies.

An additional, divided flow guide body can be provided to simplify installation in the recess in the valve housing.

In an advantageous development of the valve according to the invention, barrier bodies and/or an additional flow guide body are designed to be replaceable. As a result, the force ratios on the valve body and, therefore, the switching behavior of the valve can be adapted to different conditions.

Various embodiments of the invention are described in detail in the following with reference to the figures, which show:

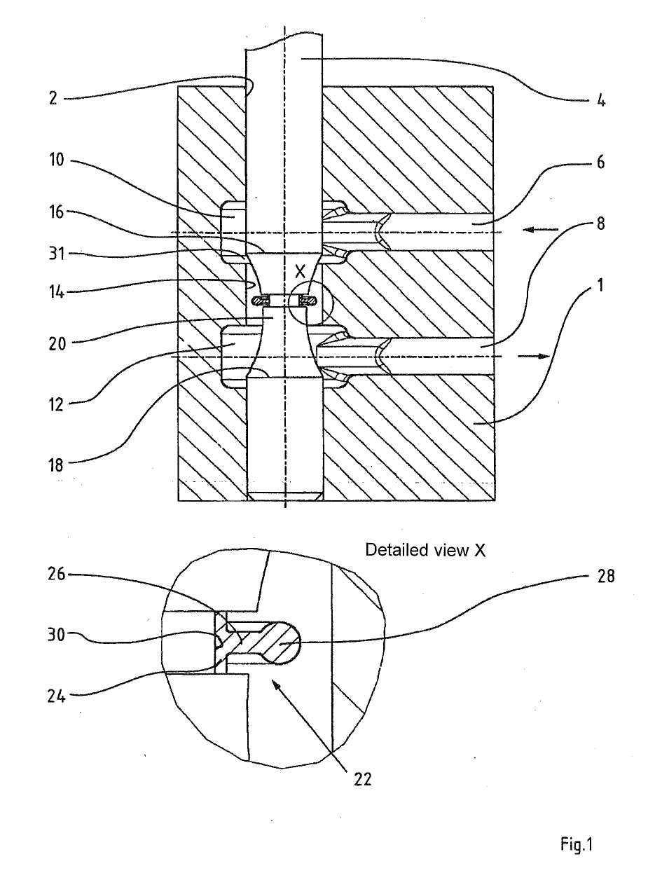

FIG. 1: a first embodiment of a valve according to the invention, including a barrier body, in a cross-sectional side view;

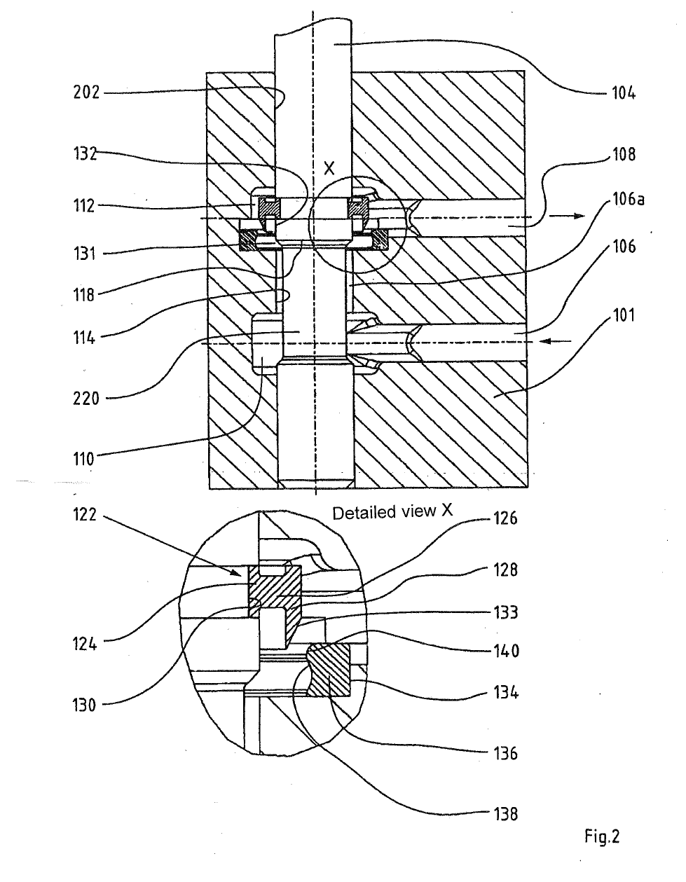

FIG. 2: a second embodiment of a valve according to the invention, including a barrier body and an additional flow guide body, in a cross-sectional side view;

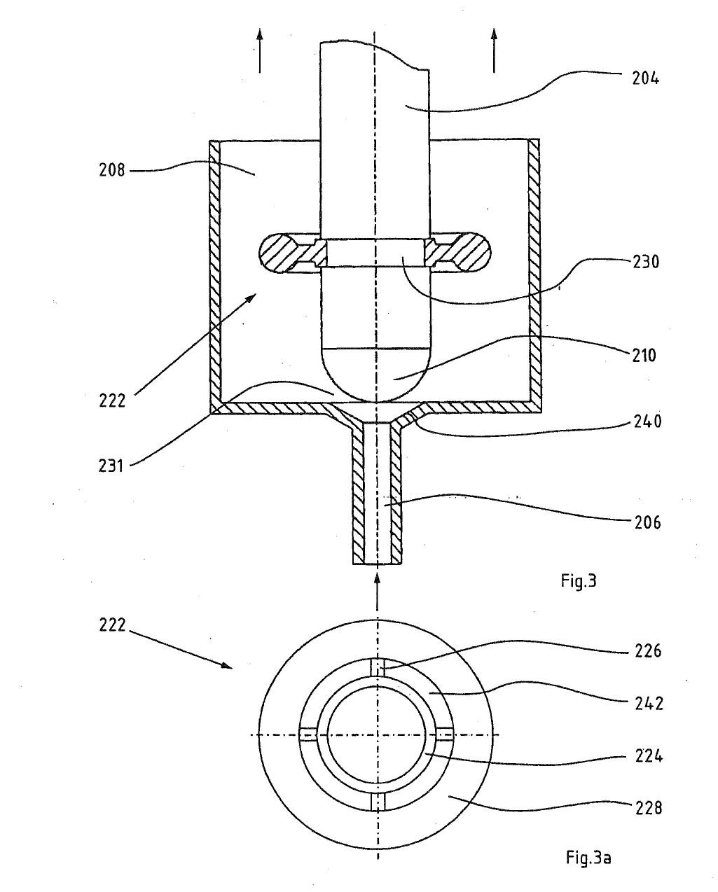

FIG. 3: a third embodiment of a valve according to the invention, including a barrier body, in a cross-sectional side view;

FIG. 3a: the barrier body according to the third embodiment, in a top view;

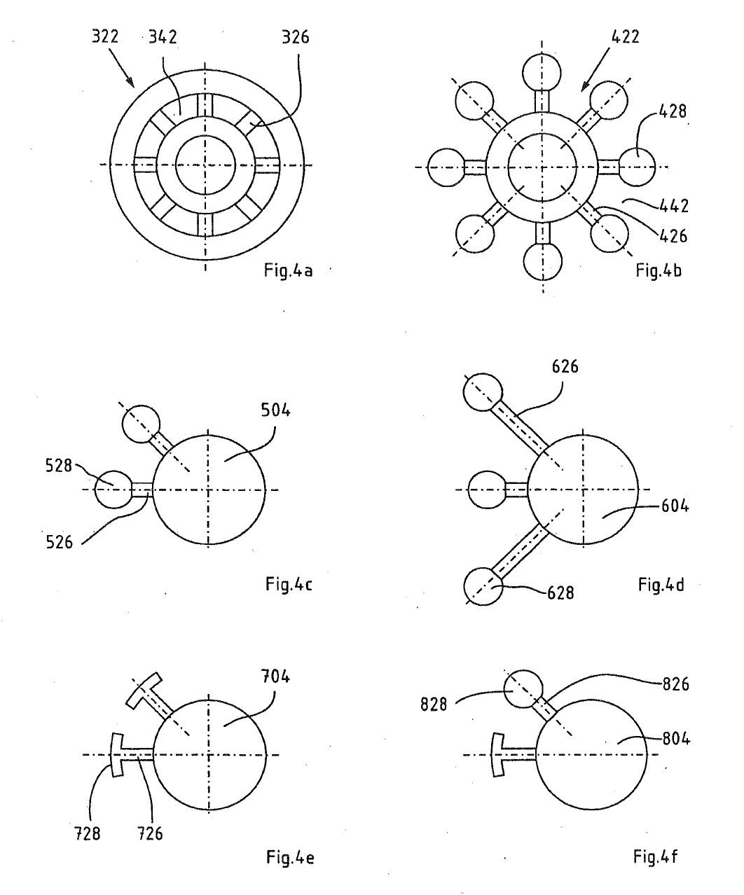

FIGS. 4a through f: six variants of barrier bodies, as examples, each shown in a top view, and

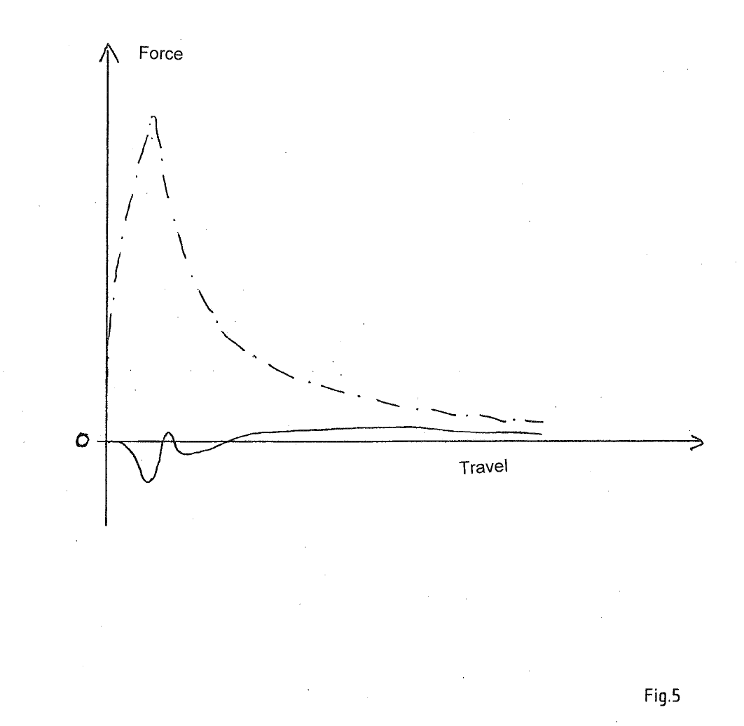

FIG. 5: a diagram depicting the adjustment force required to actuate a conventional valve and a valve according to the invention, as a function of travel.

FIG. 1 shows a first embodiment of a valve according to the invention, including a barrier body. The valve is a 2/2 directional control valve and is substantially composed of a valve housing 1 having a valve bore 2. A valve spool 4 is disposed therein, and is displaceable in the vertical direction as shown in FIG. 1. Furthermore, valve housing 1 includes a supply channel 6 and a discharge channel 8 for pressure medium. In the region in which supply channel 6 transitions into valve bore 2, a supply chamber 10 is formed, which is expanded relative to supply channel 6 and relative to valve bore 2. Accordingly, a discharge chamber 12, which is likewise expanded, is provided in the region in which valve bore 2 transitions into discharge channel 8. A housing segment 14 remains between supply chamber 10 and discharge chamber 12.

Between supply chamber 10 and discharge chamber 12, valve spool 4 includes a neck 20 formed by a flowing and continuous reduction in diameter, wherein circumferential edges that limit neck 20 are formed by a supply control edge 16 and a discharge control edge 18.

Barrier body 22 according to the invention is disposed in the space that results between supply chamber 10 and discharge chamber 12, and between housing segment 14 and neck 20 of valve spool 4. Barrier body 22 includes a base part 24, from which four radial segments 26 extend outwardly, only one of which is shown in enlarged detailled view X of FIG. 1. A flow body 28 is fastened to radial segments 26. Base part 24 has the shape of a bushing, and four segments 26 that extend away from the outer jacket surface of base part 24 are distributed around the circumference. Flow body 28 that is fastened to the outer ends of segments 26 has the shape of a torus, the longitudinal axis of which coincides with that of bushing-shaped base part 24.

A groove 30 into which base part 24 is inserted is formed in neck 20 of valve spool 4. Barrier body 22 is therefore inserted in groove 30, and is fastened to neck 20 in a form-fit manner. Flow body 28 has a larger diameter than the adjacent regions of neck 20, and a smaller diameter than valve spool 4.

FIG. 1 shows an operating state of the valve in which valve spool 4 was displaced upwardly (as shown in FIG. 1) from a closing position, which is not depicted, thereby controlling-open a flow-through cross-section. The pressure medium flows via supply channel 6 through an annular gap 31 that forms between supply control edge 16 of valve spool 4 and segment 14 of valve housing 1. Segments 26 and, in particular, toroidal flow body 28 are disposed in the portion of the pressure-medium flow path that extends between neck 20 and housing segment 14 downward to discharge chamber 12, that is, approximately downstream of the opening cross-section.

Due to the flow against or around flow body 28, which results when the valve is open, as shown, and when pressure medium flows from supply channel 6 to discharge channel 8, the flowing pressure medium transfers forces to flow body 28 by impacting or redirecting. Flow body 28 is designed such that these forces contain components that are directed upwardly along the longitudinal axis of flow body 28 in FIG. 1 and therefore act, according to the invention, in the opening direction of valve spool 4, wherein the resustant force components are transferred by segments 26, base part 24, and an edge of groove 30 to valve spool 4.

In this first embodiment, the force components that are created according to the invention are directed against the main direction of flow of the pressure medium, which extends from supply chamber 10 to discharge chamber 12.

This resultant force component can reduce, compensate for, or over-compensate for forces that act in the closing direction, which can form on discharge control edge 18, for example. In this manner, the adjusting force or holding force that would be applied to a valve of this type without a barrier body 22 or a flow body 28 can be reduced.

FIG. 2 shows a second embodiment of a valve, according to the invention, including a barrier body 122 and an additional flow guide body 136. In a manner that is comparable to the valve in the first embodiment, the 2/2 directional control valve that is shown is substantially composed of a valve housing 101 having a valve bore 202 and a rotationally symmetrical valve spool 104 disposed in valve bore 202. A supply channel 106 and a discharge channel 108 are disposed in valve housing 101, and, in their regions that intersect valve bore 202, a supply chamber 110 and a discharge chamber 112 are formed accordingly.

In a region between supply chamber 110 and discharge chamber 112, valve spool 104 includes a neck 220 having a smaller diameter; compared to neck 20 shown in the first embodiment, neck 220 has a constant diameter and, therefore, the shape of a circular cylinder. A discharge control edge 118 is formed on valve spool 104 by a bevel, on the discharge chamber-side end of neck 220. Furthermore, an annular groove 130 is provided on valve spool 104 in the region of discharge chamber 112, wherein groove 130 is situated on discharge chamber-side collar 132 of valve spool 104, in a manner that differs from the first embodiment (FIG. 1). Comparable to the first embodiment, a base part 124 of a barrier body 122 is inserted in groove 130, wherein a plurality of radial segments 126 extends outwardly from base part 124. According to the second embodiment of the invention, radial segments 126 carry a hollow-cylindrical or bushing-type flow body 128, the axis of symmetry of which coincides with that of base part 124 and of valve spool 104. Flow body 128 extends in both directions of the common axis of symmetry or longitudinal axis beyond radial segments 126, thereby overhanging on both sides. Supply-side end face 133 of flow body 128 is oblique and thereby forms a circumferential bevel in the shape of a truncated cone that faces outward.

Furthermore, an annular recess 134 in the housing is formed in discharge chamber 112, into which a flow guide body 136 fixed to the housing is inserted. Flow guide body 136, which is substantially annular in shape, includes a guide surface 138 on its inner side that has an inner diameter that increases initially and then decreases, in the direction of flow. Behind an annular detachment point 140, the inner diameter of annular flow guide body 136 increases once more, as viewed in the direction of flow. All of the changes in diameter that are described are flowing or continuous.

The valve according to the second embodiment of the present invention is depicted in an open position in FIG. 2, in which valve spool 104 has been slid upwardly from the closed position. The pressure medium flows via supply channel 106 through supply chamber 110, first through a further supply channel 106a that is formed between housing segment 114 and neck 220 of valve spool 104. Furthermore, the pressure medium flows through a controlled-open annular gap 131 that is bounded by discharge control edge 118 and housing segment 114.

An open jet, which forms on annular gap 131 and is directed outwardly, is advantageously redirected or centered and bundled by above-described guide surface 138 of flow guide body 136 substantially toward the common longitudinal axis of flow guide body 136 and barrier body 122. It is therefore directed toward barrier body 122 or flow body 128. The flowing pressure medium transfers forces to flow body 128 by impacting and redirecting. The kinetic energy of the open jet is thereby partially transferred to flow body 128, whereby this transfer of force is achieved via back pressure and/or viscous forces. Barrier body 122 is acted upon by forces that are distributed around the circumference, and that can be optimized by advantageously slanting the direction of the oblique end face 133 such that the application of force is optimized or maximized. The forces that act on barrier body 122 contain force components along its longitudinal axis, which act on valve spool 104 in the opening direction (which is upward in FIG. 2) via the form-fit connection between base part 124 and groove 130.

In this second embodiment, the resultant force components that are created according to the invention are directed in the main direction of flow of the pressure medium, which extends from supply chamber 110 to discharge chamber 112.

FIG. 3 shows a third embodiment of the valve according to the invention, including a barrier body 222. The valve that is depicted is a poppet valve, in the case of which a valve seat 240 is disposed between a supply channel 206 and a discharge channel 208, valve seat 240 being closable by a hemispherical end section 210 of a valve tappet 204.

In deviation from the third embodiment, which is shown in FIG. 3, end section 210 of valve tappet 204 can have the shape of a cone or a truncated cone, rather than the hemispherical shape that is shown.

Similar to the first embodiment (FIG. 1), valve tappet 204 includes a circumferential annular groove 230, into which a barrier body 222 having a toroidal flow body 228 is inserted.

FIG. 3a shows barrier body 222 according to the third embodiment, in a top view. Barrier body 222 that is shown can also be used in the first two embodiments (as shown in FIGS. 1 and 2) instead of barrier bodies 22, 122 that are shown. According to FIG. 3a, barrier body 222 includes four radial segments 226 that are distributed evenly around the outer circumference of base part 224. Four recesses 242 shaped as segments of a circle are formed between radial segments 226.

If valve tappet 204, as shown in FIG. 3, is displaced into an upper opening position, a passage 231 for pressure medium is opened between valve seat 240 and valve tappet 204, and a flow of pressure medium or an open jet strikes barrier body 222, wherein a portion of the pressure medium can flow through recesses 242. The flowing pressure medium transfers forces to toroidal flow body 228 by impacting and redirecting. The kinetic energy of the open jet is thereby partially transferred to flow body 228, whereby this transfer of force is achieved via back pressure and/or viscous forces. Barrier body 222 is acted upon by forces that are distributed around the circumference, and that can be optimized by its advantageous positioning and dimensioning such that the application of force is optimized or maximized. The forces that act on barrier body 122 contain force components that extend along the longitudinal axis of barrier body 122, and act on valve tappet 204 in the opening direction (which is upward in FIG. 3) via the form-fit connection between base part 224 and groove 230.

In this third embodiment, the force component that is created according to the invention is directed upward in FIG. 3.

FIGS. 4a and 4b show further examples of barrier bodies according to the invention, which can be used in the above-described valves, for example.

FIG. 4a shows a barrier body 322 that is designed similar to barrier body 222 in the third embodiment, the main difference being that eight ribs or radial segments 326 and, accordingly, eight recesses 342 shaped as segments of a circle are provided.

FIG. 4b shows a further advantageous embodiment of a barrier body 422, the main feature of which is that eight individual flow bodies 428 are provided. Each flow body 428 is substantially spherical in shape and is disposed at the same radial distance on the circumference of barrier body 422 and, therefore, on the circumference of the corresponding valve body.

FIGS. 4c through 4f show further examples of valve bodies having segments and flow bodies distributed unevenly around the circumference, according to the invention. An asymmetrical placement of this type can be optimal for flows, in particular, that occur on the circumference of the valve body such that they are distributed unevenly, wherein the segments and flow bodies shown in FIGS. 4c through 4f can also be attached to annular base parts, as an alternative, and can thereby be mounted on the valve body.

FIG. 4c shows a valve body 504, in the case of which only two spherical flow bodies 528 are provided.

FIG. 4d shows a further variant of an asymmetrical configuration, in the case of which three substantially spherical flow bodies are fastened to a valve body 604 via segments 626 having different lengths.

By providing segments 626 having different lengths, it is ensured that open-jet regions having different directions, which can occur in different operating states of the particular valve, are each detected by one or more flow bodies in an optimal manner.

FIG. 4e shows a configuration of valve body 704 and flow bodies 728 that are distributed unevenly about the circumference, wherein the main design is comparable to that shown in FIG. 4c. Segments 726 are narrower than segments 626, and, in particular, flow bodies 728 are formed by sections of a cylindrical jacket or a cylindrical ring, rather than by spheres.

FIG. 4f shows a further variant of an asymmetrical design, in the case of which geometrically different flow bodies 828 and radial segments 826 are combined on a valve body 804 according to the invention, wherein one flow body 828 and one associated segment 826 correspond to those in the example depicted in FIG. 4c, and the other flow body and the associated segment correspond to those of the example depicted in FIG. 4e.

The combined configuration depicted in FIG. 4f can be adapted to various stepless operating states of the particular valve in a more flexible manner by using different flow bodies, and can therefore generate greater forces over a larger range of operating states than is possible using most flow bodies having uniform geometries and radial distances.

FIGS. 4a through 4f merely depict individual examples of a large number of possible barrier bodies and flow bodies that belong to the present invention, although not all of them can be depicted.

FIG. 5 shows a diagram depicting the adjustment forces required to actuate a conventional valve and a valve according to the invention, as a function of opening travel. Forces to be applied in the opening direction are situated in the upper region of the diagram, and forces to be applied in the closing direction are situated in the lower region of the diagram.

In the case of a conventional valve (dash-dotted line), a high maximum force that must be applied in the opening direction obviously exists in the region of minimal travel. In the case of the valve according to the invention (solid line), however, a small force must first be applied in the closing direction shortly after the valve is opened; as the valve is opened further, three directional changes occur until only one minimal force remains in the opening direction.

The adjustment forces on a valve having a barrier body according to the invention are many times smaller than on a conventional valve. The high forces acting on the conventional valve are approximately compensated for by the invention, thereby simplifying fabrication and control to a considerable extent.

In deviation from the 2/2 directional control valves depicted in FIGS. 1 and 2, and in deviation from the poppet valve depicted in FIG. 3, the barrier bodies according to the invention can likewise be used in all other types of valves in which flow forces that act in the closing direction are reduced.

Furthermore, the guide surface of the flow guide body fixed to the housing, as depicted in FIG. 2, can likewise have a different shape, to enable flow to approach the barrier body in a different manner.

As an alternative, the flow guide body that is fixed to the housing, as depicted in FIG. 2, can also be fastened to the piston.

In deviation from the third embodiment, which is depicted in FIG. 3, the valve tappet and the barrier body can also be single-pieced in design. This can be advantageous, in particular, when no changes need be made to the force ratios on the valve tappet during operation of the valve that could only be attained by replacing the barrier body.

What is disclosed is a valve of an arbitrary type, comprising a valve body for adjusting an opening cross-section through which pressure medium flows, and a barrier body against or around which pressure medium flows, characterized in that the barrier body is attached to the valve body. Due to the flaw against or around the barrier body, a force is generated, particularly in the opening direction of the valve body.

1. A valve comprising a valve body for adjusting an opening cross-section through which pressure medium flows, and comprising a barrier body (22; 122; 222) toward or around which pressure medium flows,
characterized in that
the barrier body (22; 122; 222) is attached to the valve body (4; 104; 204).

2. The valve according to claim 1, wherein a force that can be created by the flowing toward or around the barrier body (22; 122; 222) acts in the opening direction of the valve body (4; 104; 204).

3. The valve according to claim 1, wherein the barrier bodies and the valve body (504; 604; 704) are single-pieced in design.

4. The valve according to claim 1, wherein a substantially annular base part (24; 124; 224) of the barrier body (22; 122; 222) is inserted in an annular groove (30; 130; 230) of the valve body (4; 104; 204).

5. The valve according to claim 4, wherein the barrier body (22; 122; 222) includes radial segments (26; 126; 226) that are fastened to the base part (24; 124; 224) and carry at least one flow body (28; 128; 228).

6. The valve according to claim 1, wherein the valve body is a valve spool (4; 104), and the barrier body (22; 122) is disposed on a neck (20) or on a discharge chamber-side collar (132) of the valve spool (4; 104).

7. The valve according to claim 1, wherein the barrier bodies (222; 322; 422) include recesses (242; 342; 442) through which pressure medium can flow.

8. The valve according to claim 7, wherein the recesses are bores or holes.

9. The valve according to claim 5, wherein the flow bodies (28; 128; 228) extend substantially annularly around the valve body (4; 104; 204).

10. The valve according to claim 5, wherein a plurality of flow bodies (428; 728) is distributed around the circumference of the valve body.

11. The valve according to claim 7, wherein the recesses are bounded by the flow bodies (428).

12. The valve according to claim 5, wherein the flow body is formed by a torus (28; 228) or a truncated cone, or is conical at least in sections, or at least one of the flow bodies is formed by a section of a torus or a truncated cone, or by a ball (428).

13. The valve according to claim 5, wherein the flow body is a cylindrical ring (128) or a cylindrical jacket, or at least one of the flow bodies is a cylindrical ring section (728) or a section of a cylindrical jacket.

14. The valve according to claim 13, wherein each flow body (128; 728) includes an end face (133) that is slanted in the direction of incidence.

15. The valve according to claim 1, wherein the flow body has a wing-type profile.

16. The valve according to claim 10, wherein flow bodies having different geometries are distributed around the circumference of the valve body in alternating succession.

17. The valve according to claim 10, wherein the flow bodies have different radial distances from the valve body.

18. The valve according to claim 10, wherein flow bodies are distributed around the circumference of the valve body evenly or unevenly.

19. The valve according to claim 1, wherein an annular flow guide body (136) fixed to the housing is inserted in an annular recess (134) in a valve housing (101) and, in conjunction with the at least one flow body (128), limits a flow-through cross-section.

20. The valve according to claim 19, wherein the flow guide body (136) includes a guide surface (138) that points toward the flow body (128) and overlaps the flow body (128) in a rounded manner.

21. The valve according to claim 19, wherein the flow guide body (136) is composed of a plurality of annular parts or annular segments.

22. The valve according to claim 1, wherein the barrier bodies (22; 122; 222) and/or the flow guide body (136) fixed to the housing are replaceable or changeable.
